(19) United States
(12) Patent Application Publication
(10) Pub. No.: US 2013/0307924 A1
(43) Pub. Date: Nov. 21, 2013

(54) METHOD FOR 3DTV MULTIPLEXING AND APPARATUS THEREOF

(71) Applicant: ELECTRONICS AND TELECOMMUNICATIONS RESEARCH INSTITUTE, Daejeon (KR)

(72) Inventors: Suk Hee CHO, Daejeon-si (KR); Jong Ho KIM, Daejeon-si (KR); Se Yoon JEONG, Daejeon-si (KR); Hyon Gon CHOO, Daejeon-si (KR); Jin Soo CHOI, Daejeon-si (KR); Jin Woong KIM, Daejeon-si (KR)

(73) Assignee: Electronics and Telecommunications Research Institute, Daejeon (KR)

(21) Appl. No.: 13/717,492

(22) Filed: Dec. 17, 2012

(30) Foreign Application Priority Data
May 16, 2012 (KR) 10-2012-0051878

(51) Int. Cl. H04N 13/00

(52) U.S. Cl. CPC H04N 13/0051
USPC 348/43

(57) ABSTRACT

A method for 3DTV multiplexing according to the present invention comprises, deriving a delay value in units of frames for the left and right image based on a left image PES (Packetized Elementary Stream) corresponding to a left image and a right image PES corresponding to a right image, carrying out synchronization of the left image PES and the right image PES based on the delay value in units of frames, and generating 3DTV transport streams (TSs) by carrying out multiplexing of the synchronized left image PES and the synchronized right image PES. According to the present invention, efficiency of video services can be improved.

### CROSS-REFERENCE TO RELATED APPLICATIONS

This application claims the benefit of priority of Korean Patent Application No. 10-2012-0051878 filed on May 16, 2012, which is incorporated by reference in their entirety herein.

### BACKGROUND OF THE INVENTION

1. Field of the Invention

The present invention relates to image processing. More specifically, the present invention relates to a method for 3DTV multiplexing and an apparatus thereof.

2. Discussion of the Related Art

Three dimensional (3D) digital broadcasting services are getting attention as one of the next generation broadcasting services together with UDTV services subsequent to HDTV. It is expected that owing to the advancement of related technologies such as release of high definition, commercial stereoscopic display, 3DTV service which enables people to enjoy 3D images will be provided for every home in the coming years. In particular, those 3D broadcasting services currently provided in the form of a commercial service or a trial service usually make use of stereoscopic videos consisting of left and right images.

A plurality of images correlated with each other can be stored or processed at the same time during 3D image processing. In addition to 3D images, free-viewpoint images, panoramic images, multi-view images, and multi-segmented images correlated with each other may also be stored or processed at the same time. Here, a multi-segmented image refers to an ultra-high resolution image whose resolution is four to sixteen times the resolution of an HD image divided into a plurality of HD images. As described above, in case of storing or processing a plurality of images correlated with each other at the same time, the plurality of images should be synchronized with each other in units of frames.

### SUMMARY OF THE INVENTION

An object of the present invention is to provide a method for generating 3DTV transport streams (TSs) capable of improving efficiency of video services and an apparatus thereof.

Another object of the present invention is to provide a method for 3DTV multiplexing capable of improving efficiency of video services and an apparatus thereof.

Still another object of the present invention is to provide a method for synchronizing images capable of improving efficiency of video services and an apparatus thereof.

One embodiment of the present invention is a method for 3DTV multiplexing. The method comprises deriving a delay value in units of frames for the left image and the right image, based on a left image PES (Packetized Elementary Stream) corresponding to a left image and a right image PES corresponding to a right image, carrying out synchronization of the left image PES and the right image PES, based on the delay value in units of frames, and generating 3DTV transport streams (TSs) by carrying out multiplexing of the synchronized left image PES and the synchronized right image PES, where the delay value in units of frames corresponds to a time difference between the left image and the right image expressed in units of frames.

The step of deriving a delay value in units of frames may further comprise extracting a first synchronization information value from a first video ES (Elementary Stream) within the left image PES and extracting a second synchronization information value from a second video ES within the right image PES; and deriving the delay value in units of frames based on the first synchronization information value and the second synchronization information value.

The first synchronization information value can be counted in units of frames and included in the first video ES, and the second synchronization information value can be counted in units of frames and included in the second video ES; and the step of deriving the delay value in units of frames may comprises determining the time difference between the first synchronization information value and the second synchronization information value by the delay value in units of frames.

The first synchronization information value can be the value included in the first video ES in the form of a time code, and the second synchronization information value can be the value included in the second video ES in the form of a time code; and the step of deriving the delay value in units of frames can further comprise deriving a time difference in units of seconds between the first synchronization information value and the second synchronization information value and deriving the delay value in units of frames by multiplying the time difference in units of seconds with the number of frames per second.

The synchronized left image PES can further comprise a first PTS (Presentation Time Stamp) and a first DTS (Decoding Time Stamp), and the synchronized right image PES can further comprise a second PTS and a second DTS; and the step of carrying out synchronization can further comprise modifying the values of the first PTS, the first DTS, the second PTS, and the second DTS into new values, based on a third PTS fed from a clock.

The modifying step may further comprise modifying a value of the first and a value of the second PTS into a value of the third PTS, and modifying a value of the first DTS into a value obtained by adding the value of the third PTS to a value obtained after subtracting the value of the first PTS from the value of the first DTS; and modifying a value of the second DTS into a value obtained by adding the value of the third PTS to a value obtained after subtracting the value of the second PTS from the value of the second DTS.

The method for 3DTV multiplexing can further comprise generating 3DTV PSI, which is 3D program structure information, based on left image PSI (Program Specific Information) corresponding to the left image and right image PSI corresponding to the right image and the step of generating 3DTV TS can comprise carrying out multiplexing of the synchronized left image PES, the synchronized right image PES, and the 3DTV PSI.

The left image PSI can include a first PAT (Program Association Table) and a first PMT (Program Map Table), and the right image PSI can include a second PAT and a second PMT. The step of generating 3DTV PSI can further comprise generate a third PAT having information corresponding to both of the first PMT and the second PMT by re-composing the first PAT and the second PAT; change a stream type value within one PMT corresponding to an additional stream from among the first PMT and the second PMT; and insert in one PMT corresponding to the additional stream, program information descriptor in which information specifying type of program provided by digital broadcasting is defined, and video information descriptor in which information specifying characteristics of ES constituting video data is defined.

The method for 3DTV multiplexing can further comprise extracting the left image PES from a left image TS (transport stream) corresponding to the left image and extracting the right image PES from a right image TS corresponding to the right image.

Another embodiment of the present invention is an apparatus for 3DTV multiplexing. The apparatus comprises a delay calculation module for deriving a delay value in units of frames with respect to the left and the right image, based on a left image PES (Packetized Elementary Stream) corresponding to a left image and a right image PES corresponding to a right image, a synchronization module for carrying out synchronization between the left image PES and the right image PES, based on the delay value in units of frames, and a 3DTV TS packetizer for generating 3DTV transport streams (TSs) by carrying out multiplexing of the synchronized left and right image PES, where the delay value in units of frames corresponds to a time difference between the left image and the right image expressed in units of frames.

The delay calculation module can further comprise a first synchronization information extractor extracting a first synchronization information value from a first video ES (Elementary Stream) within the left image PES, a second synchronization information extractor extracting a second synchronization information value from a second video ES within the right image PES, and a delay calculator deriving the delay value in units of frames based on the first synchronization information value and the second synchronization information value.

The synchronized left image PES can further comprise a first PTS (Presentation Time Stamp) and a first DTS (Decoding Time Stamp); the synchronized right image PES can further comprise a second PTS and a second DTS, and the synchronization module can further comprise a PTS/DTS modifying module which modifies the values of the first PTS, the first DTS, the second PTS, and the second DTS into new values, based on a third PTS fed from a clock.

The apparatus for 3DTV multiplexing can further comprise a 3DTV PSI generation module for generating 3DTV PSI, which is 3D program structure information, based on left image PSI (Program Specific Information) corresponding to the left image and right image PSI corresponding to the right image, and the 3DTV TS packetizer can carry out multiplexing of the synchronized left image PES, the synchronized right image PES, and the 3DTV PSI.

The apparatus can further comprise a first de-packetizer extracting the left image PES from a left image TS (transport stream) corresponding to the left image and a second de-packetizer extracting the right image PES from a right image TS corresponding to the right image.

Still another embodiment of the present invention is a method for synchronizing images. The method comprises deriving a delay value in units of frames with respect to the left and the right image, based on a left image PES (Packetized Elementary Stream) corresponding to a left image and a right image PES corresponding to a right image, and carrying out synchronizing the left image and the right image PES with each other, based on the delay value in units of frames, where the delay value in units of frames is a time difference between the left image and the right image expressed in units of frames.

### BRIEF DESCRIPTION OF THE DRAWINGS

The accompanying drawings, which are included to provide a further understanding of described embodiments of the present invention and are incorporated in and constitute a part of this specification, illustrate embodiments of the present invention and together with the description serve to explain aspects and features of the present invention.

FIG. 1 briefly illustrates one embodiment of a 3DTV TS generation process;

FIG. 2 briefly illustrates another embodiment of a 3DTV TS generation process;

FIG. 3 briefly illustrates an embodiment of an apparatus for generating 3DTV TS according to the present invention;

FIG. 4 is a block diagram illustrating briefly one embodiment of the structure of a DTV encoder;

FIG. 5 is a block diagram illustrating briefly one embodiment of the structure of 3DTV multiplexer based on automatic synchronization according to the present invention;

FIG. 6 is a block diagram illustrating briefly one embodiment of the structure of a synchronization module included in a 3DTV multiplexer based on an automatic synchronization of FIG. 5;

FIG. 7 is a block diagram illustrating briefly one embodiment of a delay calculation module included in a synchronization module of FIG. 6; and

FIG. 8 is a flow diagram illustrating briefly one embodiment of a method for 3DTV multiplexing based on automatic synchronization according to the present invention.

### DETAILED DESCRIPTION OF THE INVENTION

Hereinafter, an embodiment of the present invention will be described in more detail with reference to the accompanying drawings. In describing embodiments of the present invention, in case where it is determined that detailed description of related prior knowledge or functions may obscure the technical principles and scope of the present invention, the description will be omitted.

If some constituting element is mentioned to be “linked” or “connected” to other constituting element, it usually refers to the case where the former element is directly linked or connected to the latter element, but chances of another constituting element existing between the two elements should also be taken into consideration. Also, “including” a particular composition according to the present invention does not exclude other compositions than the particular composition, which implies that additional composition may belong to the embodiments or technical principles of the present invention.

Terms such as first, second, and so on may be used for describing various constituting elements but the constituting elements should not be limited by the terms used. The terms are used only for the purpose of distinguishing one element from the others. For example, a first constituting element may be referred to as a second constituting element without departing the technical scope of the present invention; similarly, a second constituting element may be referred to as a first constituting element.

Moreover, constituting units introduced in the embodiments of the present invention are described independently to illustrate characteristic functions different from each other, which does not imply that each constituting unit is comprised of in units of separated single hardware or software. In other words, each constituting unit is introduced in this document as such for the convenience of description; for example, at least two constituting units may be combined into a single unit or a single unit may be divided into a plurality of constituting units carrying out a function. Therefore, it should be understood that embodiments incorporating integration of constituting units or division of constituting units into smaller ones all fall into the technical scope defined by the appended claims unless the embodiments escape from the technical principles.

Further, part of constituting elements may be optional introduced just to enhance performance, not being essential elements for carrying out fundamental functions of the present invention. The present invention can be realized by incorporating only such elements essential for implementing technical principles of the present invention, excluding those elements used only for performance enhancement; the structure which employs only those essential elements excluding optional elements used only for performance enhancement can also be regarded to fall into the technical scope of the present invention.

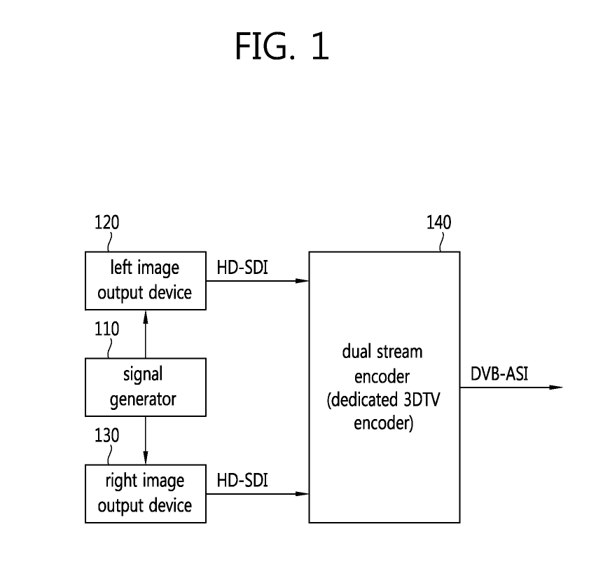

FIG. 1 briefly illustrates one embodiment of a 3DTV TS generation process. Here, TS may refer to a transport stream. FIG. 1 illustrates a process for generating 3DTV TSs for stereoscopic 3DTV services.

In case a plurality of images such as 3D images, free-viewpoint images, multi-view images, panoramic images, and the like are stored or processed together, the plurality of image signals should be synchronized in units of frames. Since stereoscopic video can consist of left and right image signal, the left image signal and the right image signal in the embodiment of FIG. 1 should be synchronized to each other in units of frames.

In case of 3D image, free-viewpoint image, multi-view image, panoramic image, and the like, individual images may be encoded by different encoders from each other. In this case, a plurality of transport streams may be output by a plurality of encoders. For example, left and right images of a stereoscopic video may be encoded respectively by an MPEG (Moving Picture Experts Group)-2 encoder and an AVC (Advanced Video Coding) encoder. At this time, as described above, a plurality of transport streams should be synchronized to each other in units of frames. However, if a method for automatically synchronizing a plurality of transport streams is not available, a dedicated 3DTV encoder which encodes a plurality of images (e.g., left and right image of a stereoscopic video) together may be used.

In the embodiment of FIG. 1, a dedicated 3DTV encoder may be employed for generating 3DTV TSs. With reference to FIG. 1, a signal generator 110 can generate left and right image signals. A left image output device 120 receives the left image signals and can output HD-SDI (High Definition Serial Digital Interface) signals corresponding to the left image signals (hereinafter, it is called ‘left image HD-SDI’) while a right image output device 130 receives the right image signals and can output HD-SDI signals corresponding to the right image signals (hereinafter, it is called ‘right image HD-SDI’). Here, the HD-SDI may represent standard specifications for image transmission between HD broadcasting equipment. A dual stream encoder (a dedicated 3DTV encoder) 140 can generate DVB-ASI (Digital Video Broadcast Asynchronous Serial Interface) signals based on left and right image HD-SDI. At this time, the DVB-ASI may represent standard specifications for serial transmission of digital video/audio streams between devices. DVB-ASI signals generated by the dual stream encoder 140 as shown in FIG. 1 may correspond to multiplexed 3DTV transmission streams.

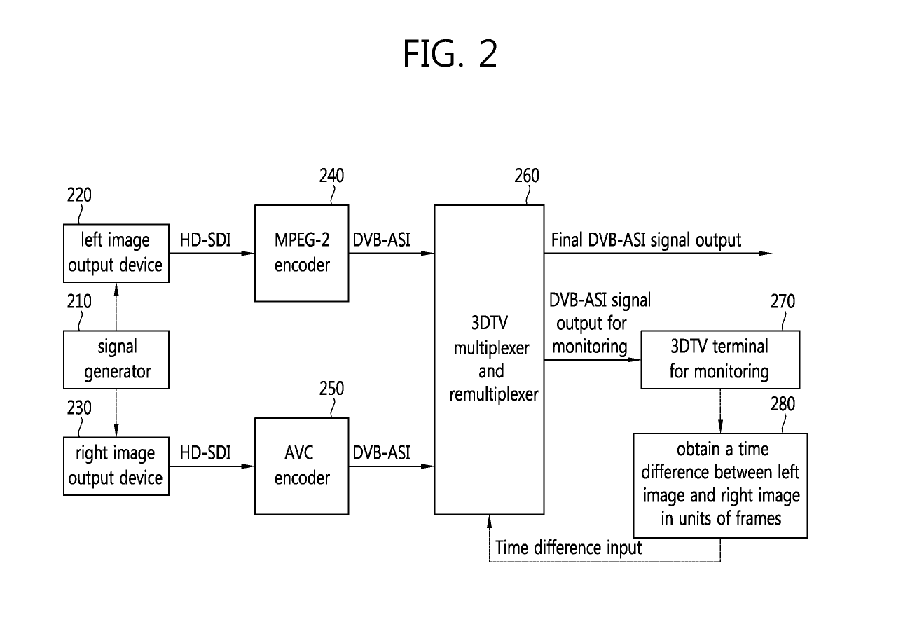

FIG. 2 briefly illustrates another embodiment of a 3DTV TS generation process. FIG. 2 illustrates a 3DTV TS generation process for stereoscopic 3DTV services.

As described above, in case of storing or processing a plurality of images such as 3D images, free-viewpoint images, multi-view images, and panoramic images at the same time, a plurality of image signals should be synchronized to each other in units of frames. Since a stereoscopic video may consist of left and right image signals, as shown in the embodiment of FIG. 2, the left and right image signals should be synchronized to each other in units of frames.

Individual images of 3D images, free-viewpoint images, multi-view images, and panoramic images may be encoded by encoders different from each other. At this time, a plurality of transport streams may be output by a plurality of encoders. For example, as shown in the embodiment of FIG. 2, left and right images of a stereoscopic video may be encoded respectively by an MPEG-2 encoder and an AVC encoder. At this time, as described in detail above, a plurality of transport streams should be synchronized to each other in units of frames. However, if a method for automatically synchronizing a plurality of transport streams is not available, a method of manually synchronizing a plurality of image signals may be employed.

With reference to FIG. 2, a signal generator 210 can generate left and right image signals. A left image output device 220 receives the left image signals and can output left image HD-SDI while a right image output device 230 receives the right image signals and can output right image HD-SDI. Also, an MPEG-2 encoder 240, based on the left image HD-SDI signals, can generate DVB-ASI signals corresponding to left images (hereinafter, it is called left image DVB-ASI) while an AVI encoder 250, based on the right image HD-SDI signals, can generate DVB-ASI signals corresponding to the right images (hereinafter, it is called right image DVB-ASI).

Again, with reference to FIG. 2, a 3DTV multiplexer and remultiplexer 260, by carrying out multiplexing based on left image DVB-ASI and right image DVB-ASI, can generate and output DVB-ASI signals for monitoring. The output DVB-ASI signals for monitoring can be input to a 3DTV terminal for monitoring. At this time, a time difference between a left and a right image in units of frames can be obtained through the 3DTV terminal for monitoring 270. The obtained time difference in units of frames can be manually input to the 3DTV multiplexer and remultiplexer 260. At this time, the 3DTV multiplexer and remultiplexer 260, by carrying out remultiplexing of left and right image DVB-ASI based on input information about time difference, can generate and output final DVB-ASI signals. The final DVB-ASI signals can correspond to multiplexed 3DTV transport streams.

In the embodiment described in detail above, a 3DTV multiplexer and remultiplexer based on manual synchronization may be used. In other words, according to the above embodiment, a human can check a time difference in units of frames between left and right images by his or her naked eyes; and left and right frames can be synchronized manually based on the time difference.

Meanwhile, as in the embodiment of FIG. 1 described in detail above, in case of using a dedicated 3DTV encoder, new high-priced equipment is necessary for generating a 3DTV TS. Also, a method for generating a 3DTV TS according to the embodiment of FIG. 1 has a drawback of not being able to utilize existing encoders. Also, in the embodiment of FIG. 2, an output multiplexed stream is played in a 3DTV terminal for monitoring and a human carries out synchronization manually by watching an image played. Therefore, a method for generating a 3DTV TS of FIG. 2 has a drawback that it necessarily requires a terminal for monitoring. Also, the method for generating a 3DTV TS of FIG. 2 has a disadvantage that human operation is involved. Therefore, in order to solve such problems, a method for 3DTV multiplexing based on automatic synchronization can be provided.

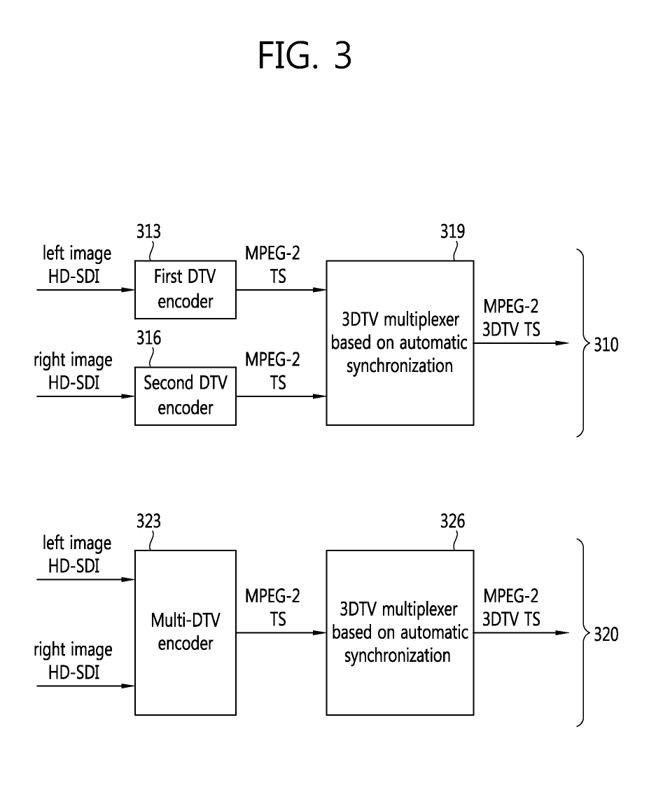

FIG. 3 briefly illustrates an embodiment of an apparatus for generating 3DTV TS according to the present invention.

FIG. 3 illustrates an apparatus for generating 3DTV TS for stereoscopic 3DTV services. Left and right images comprising stereoscopic images may be the images taken at different viewpoints for the same scene. However, in the embodiments described later, it is assumed that a plurality of images processed together for generating 3DTV TS have contents and/or programs different from each other even for the case of images associated with the same scene.

An apparatus 310 for generating 3DTV TS of FIG. 3 can comprise a first DTV encoder 313, a second DTV encoder 316, and a 3DTV multiplexer 319 based on automatic synchronization. Also, an apparatus 320 for generating 3DTV TS of FIG. 3 may comprise a multi DTV encoder 323 and a 3DTV multiplexer 326 based on automatic synchronization.

A 3DTV multiplexer based on automatic synchronization according to the present invention can receive two types of inputs as shown in FIG. 3, 310, 320. In the unit 310 of FIG. 3, left and right image signals consisting of a stereoscopic video can be encoded separately from each other through two separate encoders 313, 316. In this case, a 3DTV multiplexer 319 based on automatic synchronization can receive two MPEG-2 TSs. Also, in the unit 320 of FIG. 3, left and right image signals consisting of a stereoscopic video can be encoded together at a multi DTV encoder 323. Here, the multi DTV encoder 323 can carry out encoding of a plurality of contents within a single encoder. In this case, signals input to the 3DTV multiplexer 326 from the multi DTV encoder 323 based on automatic synchronization may correspond to one MPEG-2 TS. At this time, the MPEG-2 TS may include two contents and/or programs.

With reference to 310 of FIG. 3, a first DTV encoder 313 encodes video and/or audio signals included in the left image HD-SDI and can output MPEG-2 TSs corresponding to left images (hereinafter, it is called left image MPEG-2 TS). Also, a second DTV encoder 316 encodes video and/or audio signals included in the right image HD-SDI and can output MPEG-2 TSs corresponding to right images (hereinafter, it is called right image MPEG-2 TS). At this time, each of left and right image HD-SDI may include both of video and audio signals or may not include audio signals. Operation of the respective DTV encoders will be described later.

As shown in 310 of FIG. 3, a 3DTV multiplexer based on automatic synchronization 319 can generate an MPEG-2 3DTV TS by carrying out multiplexing based on left and right image MPEG-2 TS. At this time, an MPEG-2 3DTV TS generated may correspond to a multiplexed 3DTV transport stream. Detailed operation of the 3DTV multiplexer based on automatic synchronization 319 will be described later.

With reference to 320 of FIG. 3, a multi DTV encoder 323 carries out encoding of left and right image HD-SDI and can output one MPEG-2 TS. At this time, each of left and right image HD-SDI may include both of video and audio signals or may not include audio signals. Also, the one MPEG-2 TS may include two contents and/or programs.

As shown in 320 of FIG. 3, a 3DTV multiplexer based on automatic synchronization 326 carries out multiplexing based on one MPEG-2 TS generated by the multi DTV encoder 323 and can generate an MPEG-2 3DTV TS. At this time, an MPEG-2 3DTV TS generated may correspond to a multiplexed 3DTV transport stream. Detailed operation of the 3DTV multiplexer based on automatic synchronization 319 will be described later.

Meanwhile, two separate encoders 313, 316 are used for 310 of FIG. 3. Therefore, in this case, Program Clock Reference (PCR) for left image MPEG-2 TS generated at a first DTV encoder 313 and PCR for right image MPEG-2 TS generated at a second DTV encoder 316 may be different from each other. For 320 of FIG. 3, a multi DTV encoder 323 is employed and an MPEG-2 TS generated by the multi DTV encoder 323 may include a plurality of programs. PCR for the plurality of programs may be the same to each other. At this time, PCR may refer to a reference value for the time transmitted to a receiver being included in a transport stream in order to make the receiver set the time reference to a transmitter. However, in both of embodiments of 310 and 320 of FIG. 3, time information among a plurality of programs may not be synchronized to each other. In other words, in the embodiments of 310 and 320 of FIG. 3, among encoded streams output from an encoder(s), an encoded stream corresponding to left images (hereinafter, it is called a left image stream) and an encoded stream corresponding to right images (hereinafter, it is called a right image stream) may not be synchronized to each other.

Therefore, in order to provide a stereoscopic 3DTV service consisting of two images comprising left and right images, left and right image stream output from an encoder(s) should be automatically synchronized in units of frames. An MPEG-2 3DTV TS generated based on automatic synchronization enables stereoscopic 3DTV services. A method for automatically synchronizing a plurality of encoded streams (for example, operation of a 3DTV multiplexer based on automatic synchronization) will be described later.

In the embodiment described in detail above, it was assumed that output signals of a DTV encoder was an MPEG-2 TS; however, the present invention is not limited to the above assumption and each output signal may correspond to a transport stream of different specifications from the MPEG-2.

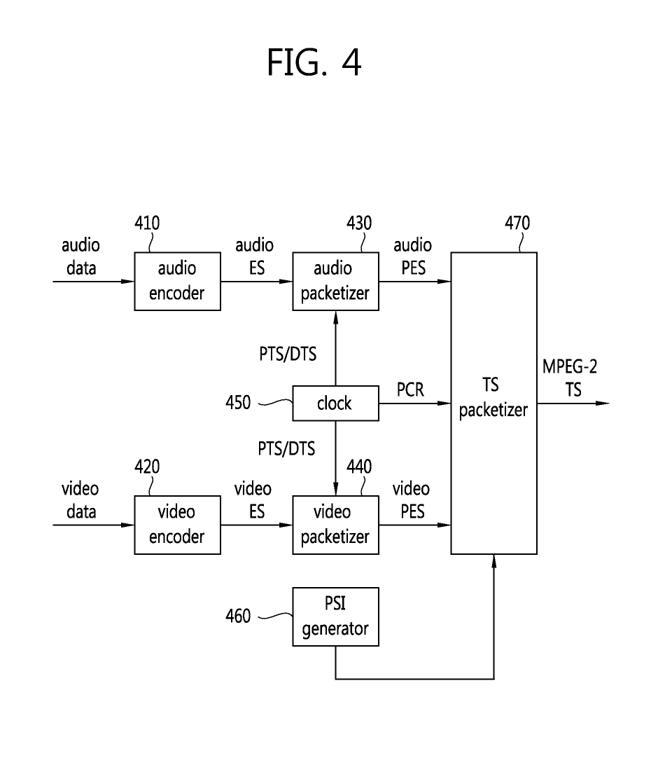

FIG. 4 is a block diagram illustrating briefly one embodiment of the structure of a DTV encoder. A DTV encoder according to an embodiment of FIG. 4 can comprise an audio encoder 410, a video encoder 420, an audio packetizer 430, a video packetizer 440, a clock 450, a PSI generator 460, and a TS packetizer 470.

With reference to FIG. 4, the audio encoder 410 can generate an audio Elementary Stream (ES) by encoding audio data included in HD-SDI. Also, the video encoder 420 can generate a video ES by encoding video data included in the HD-SDI.

The audio packetizer 430 can generate audio PES based on an audio ES and a clock signal including PTS/DTS. Also, the video packetizer 440 can generate video PES based on a video ES and a clock signal including PTS/DTS. The PTS and DTS can be obtained by the clock 450. Here, DTS (Decoding Time Stamp) may correspond to a value representing a time point at which an ES should be decoded while PTS (Presentation Time Stamp) may correspond to a value representing a time point at which a decoded access unit should be played. Also, a PES (Packetized Elementary Stream) may imply a stream comprising packets created as bit streams about compressed video/audio data are packetized.

The PSI generator 460 can generate program specific information (PSI) corresponding to program structure information. PSI is meta data and carries information required for remultiplexing and playback of image information in the form of table structure. One embodiment of PSI may comprise PAT (Program Association Table) information and PMT (Program Map Table) information. Here, PAT may include a list of all programs which can be used for current TS. PAT may include a program number indicating which program comprises a currently transmitted TS and a packet identifier (PID) corresponding to each program. Also, PMT may include program elements comprising a program and/or information about a video stream comprising video data of a program.

The TS packetizer 470 can output MPEG-2 TS signals by carrying out multiplexing of audio PES, video PES, PCR information created at the clock 450, PAT information created at the PSI generator 460, and PMT information.

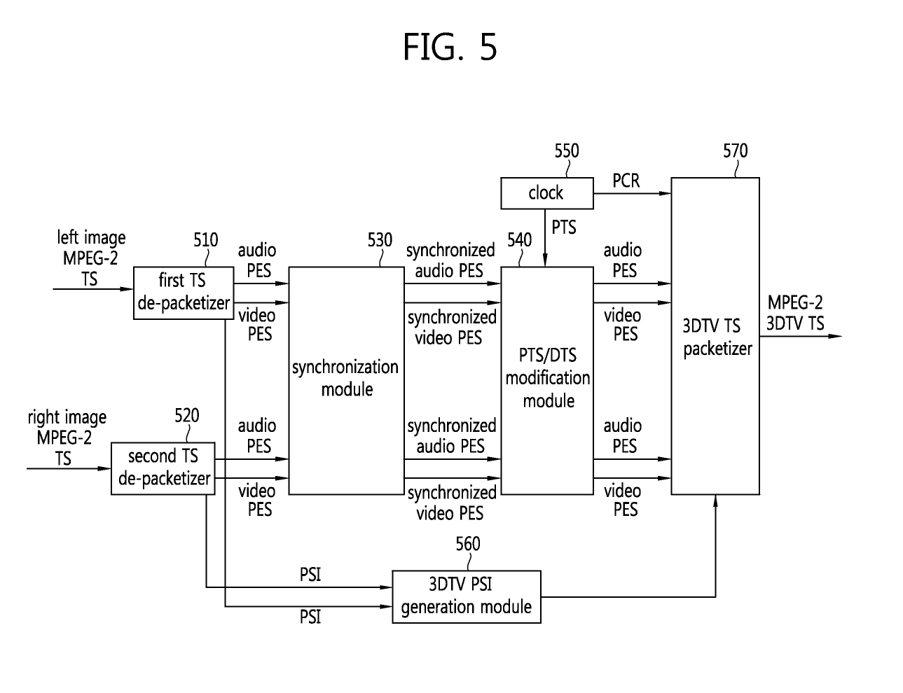

FIG. 5 is a block diagram illustrating briefly one embodiment of the structure of 3DTV multiplexer based on automatic synchronization according to the present invention

A 3DTV multiplexer based on automatic synchronization according to an embodiment of FIG. 5 can comprise a first de-packetizer 510, a second de-packetizer 520, a synchronization module 530, PTS/DTS modification module 540, a clock 550, a 3DTV PSI generation module 560, and a 3DTV TS packetizer 570.

With reference to FIG. 5, the first de-packetizer 510 receives a left image MPEG-2 TS and can generate an audio PES corresponding to the left images based on the left image MPEG-2 TS, a video PES corresponding to the left images, and PSI corresponding to the left images (hereinafter, it is called left image PSI). The audio PES and video PES generated at the first de-packeter 510 can be input to the synchronization module and the left image PSI can be input to the 3DTV PSI generation module 560. Also, the second de-packetizer 520 receives a right image MPEG-2 TS and can generate an audio PES corresponding to the right images based on the right image MPEG-2 TS, a video PES corresponding to the right images, and PSI corresponding to the right images (hereinafter, it is called right image PSI). The audio PES and video PES generated at the second de-packeter 520 can be input to the synchronization module and the right image PSI can be input to the 3DTV PSI generation module 560. In other words, each MPEG-2 TS input to a 3DTV multiplexer based on automatic synchronization can be separated into PES signals and be input to the synchronization module; PSI generated based on each MPEG-2 TS can be input to the 3DTV generation module.

It is assumed for FIG. 5 that signals input to the first 510 and the second de-packetizer 520 are all MPEG-2 transport streams; however, the present invention is not limited to the above assumption and individual signals may correspond to different types of transport stream from each other.

The synchronization module 530 carries out synchronizing a plurality of PES input and can output a plurality of synchronized PES. The synchronization module 530 can extract synchronization information from elementary stream (ES) included in each of a plurality of input PES and based on the extracted synchronization information, carry out synchronization of left and right image signals in units of frames. Synchronized PES output from the synchronization module 530 may include left image audio PES, left image video PES, right image audio PES, and right image video PES. Detailed description about operation and/or structure of the synchronization module 530 and synchronization information will be provided later.

The PTS/DTS modification module 540 can modify the PTS value about each of a plurality of PES input in synchronization with each other into a new PTS value input from the clock 550. Also, the PTS/DTS modification module 540, based on the existing PTS value extracted, the existing DTS value extracted, and a new PTS value modified, can modify a DTS value about each of a plurality of PES input in synchronization with each other into a new DTS value. For example, the PTS/DTS modification module 540 can calculate a time difference between the existing PTS value extracted and the existing DTS value extracted for each PES and calculate a new DTS value by adding the calculated time difference value to a new PTS value input from the clock 550. Here the new DTS value can be obtained for each PES input to the PTS/DTS modification module 540. At this time, the PTS/DTS module 540, for each PES, can modify the existing DTS value into the new DTS value obtained.

The following mathematical equation 1 is one embodiment of a procedure for calculating a new DTS value for a single video PES.

Diff_DTS_PTS_PES_video1=current_DTS_PES_video1−current_PTS_PES_video1

New_DTS_PES_video1=New_PTS+Diff_DTS_PTS_PES_video1 [Eq. 1]

In the Eq. 1, New_PTS may refer to a new PTS value input from the clock 550. Also, current_DTS_PES_video1 and current_PTS_PES_video1 may represent respectively the existing DTS and PTS value included in the single video PES. New_DTS_PES_video1 may represent a new DTS value obtained from the PTS/DTS modification module 540. At this time, since the PTS/DTS modification module 540 calculates a new DTS value for each PES, the number of times the PTS/DTS modification module 540 calculates a new DTS value may be the same as the number of PES input to the PTS/DTS modification module 540.

The 3DTV PSI generation module 560 can generate 3DTV PSI corresponding to the program structure information based on left and right image PSI. Here, 3DTV PSI may include PAT information, PMT information, and so on.

As described in detail above, PAT can include a list of all programs which can be used for current TS and include a program number indicating which program comprises a currently transmitted TS and a packet identifier (PID) corresponding to each program. Meanwhile, since TS output from the DTV encoder according to the embodiment of FIG. 4 includes a single program and two TSs (left and right image TS) are input to the 3DTV multiplexer of FIG. 5, 3DTV TS output from the 3DTV multiplexer of FIG. 5 can include two programs (a program corresponding to left images and a program corresponding to right images). Therefore, the 3DTV PSI generation module 560, by reconfiguring PAT, can make a single PAT correspond to two PMTS and/or make a single PAT have two pieces of PMT information. At this time, two pieces of PMT information may be PMT information corresponding to left image PSI and PMT information corresponding to right image PSI.

Meanwhile, as described in detail above, PMT may include program elements comprising a program and/or information about an image stream comprising image data within a program. PMT may include a program information descriptor defining information specifying a program type provided by digital broadcasting (e.g., stereoscopic_program_info_descriptor), a video information descriptor defining information specifying characteristics of ES comprising image data (e.g., stereoscopic_video_infor_descriptor) and/or stream type (e.g., stream_type), and so on.

The 3DTV PSI module 560 can leave one PMT intact from the two pieces of PMT information (PMT information corresponding to left image PSI and PMT information corresponding to right image PSI) and modify stream type values of video and audio stream from the remaining one PMT. Here, the stream type can be represented as stream_type, for example.

As one embodiment, it is assumed that transport streams are output respectively from an MPEG-2 encoder and an AVC encoder. In this case, the TS output from the MPEG-2 encoder is called MPEG-2 TS while the TS output from the AVC encoder is called AVC TS. At this time, to maintain compatibility between the existing DTV and 3DTV, the 3DTV PSI generation module 560 may not modify the PMT included in the MPEG-2 TS. Also, the 3DTV PSI generation module 560 can modify stream types of a video and audio stream (e.g., stream_type) within the PMT included in the AVC TS. The 3DTV PSI generation module 560, by changing the stream type value, can enable a 3DTV receiver to know that an additional encoded stream for a 3DTV service has been encoded by the AVC encoder.

Also, the 3DTV PSI generation module 560 may insert and/or incorporate a program information descriptor and a video information descriptor defined by MPEG system standard specifications for 3DTV signaling into the PMT of an additional encoded stream. Here, the program information descriptor may be represented by stereoscopic_program_info_descriptor, for example; the video information descriptor may be represented by stereoscopic_video_info_descriptor, for example. The following Table 1 and 2 are the respective embodiments of syntax of a program information descriptor (stereoscopic_program_infor_descriptor) and a video information descriptor (stereoscopic_video_infor_descriptor) inserted or incorporated into the PMT of an additional encoded stream.

TABLE 1

| | |
|---|---|
| | Number |
| Syntax | of bits |

stereoscopic_program_info_descriptor( ) {

| | |
|---|---|
| descriptor_tag | 8 |
| descriptor_length | 8 |
| reserved | 5 |
| stereoscopic_service_type | 3 |

}

TABLE 2

| | |
|---|---|
| | Number |
| Syntax | of bits |

Stereoscopic_ video_info_descriptor( ) {

| | |
|---|---|
| descriptor_tag | 8 |
| descriptor_length | 8 |
| reserved | 7 |
| base_video_flag | 1 |
| if(base_video_flag) { | |

| | |
|---|---|
| reserved | 7 |
| leftview_flag | 1 |

}
else {

| | |
|---|---|
| reserved | 7 |
| usable_as_2D | 1 |
| horizontal_upsampling_factor | 4 |
| vertical_upsampliing_factor | 4 |

}

}

Meanwhile, similar to the TS packetizer of FIG. 4, the 3DTV TS packetizer 570 can carry out multiplexing of a plurality of input PESs synchronized, PCR which is the time information generated at the clock 550, and the 3DTV PSI generated at the 3DTV PSI generation module 560; and output 3DTV-TS signals.

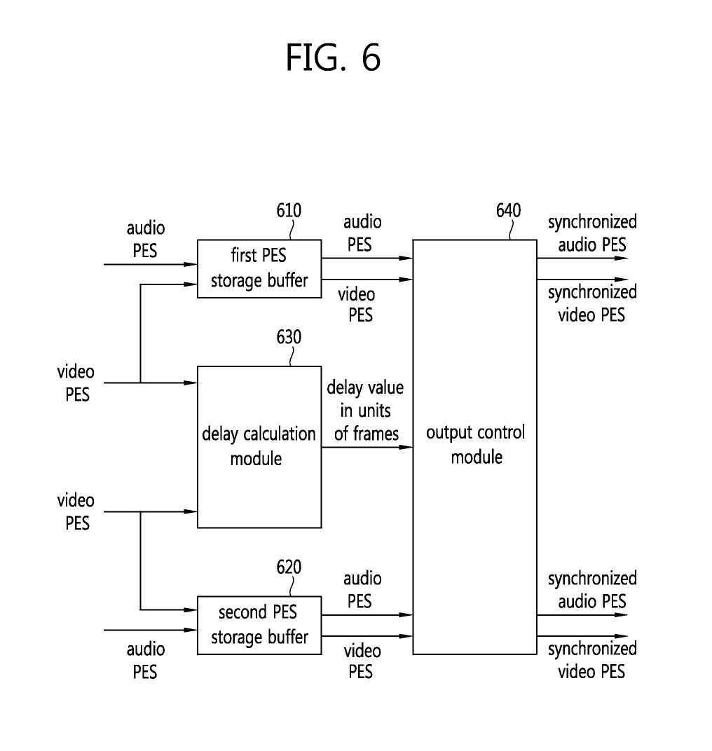

FIG. 6 is a block diagram illustrating briefly one embodiment of the structure of a synchronization module included in a 3DTV multiplexer based on an automatic synchronization of FIG. 5. The synchronization module according to the embodiment of FIG. 6 can comprise a first PES storage buffer 610, a second PES storage buffer 620, a delay calculation module 630, and an output control module 640.

With reference to FIG. 6, the synchronization module can receive a plurality of PES. In one embodiment, a plurality of PES input to the synchronization module may comprise an audio PES corresponding to left images, a video PES corresponding to left images, an audio PES corresponding to right images, and a video PES corresponding to right images.

A plurality of PES input to the synchronization module may be stored in the PES storage buffer. With reference to FIG. 6, the first PES storage buffer 610 can store left image audio and video PES. Also, the second PES storage buffer 620 may store right image audio and video PES.

The delay calculation module 630, based on the left and right image video PES, can calculate a delay value in units of frames between left (or left image encoded stream) and right images (or right image encoded stream). At this time, the delay value in units of frames may correspond to the value representing a time difference between left and right images in units of frames. In other words, a delay value in units of frames can correspond to the value indicating how much difference in frames (and/or difference in delay) exists between left and right images. The delay calculation module 630 can calculate the delay value in units of frames based on the synchronization information included in the ES within the left image video PES and the synchronization information included in the ES within the right image video PES.

Once a delay value in units of frames with respect to a left and right image encoded stream, unless error occurs in the left image encoded stream and/or the right image encoded stream, the delay value in units of frames can be kept to the same value until a program is completed. Therefore, the synchronization module (and/or the delay calculation module) may not calculate a delay value in units of frames for each PES after calculating a delay value in units of frames for the first time. In this case, the synchronization module (and/or delay calculation module) can check whether a delay value in units of frames has changed by periodically calculating the delay value in units of frames, thereby carrying out synchronization.

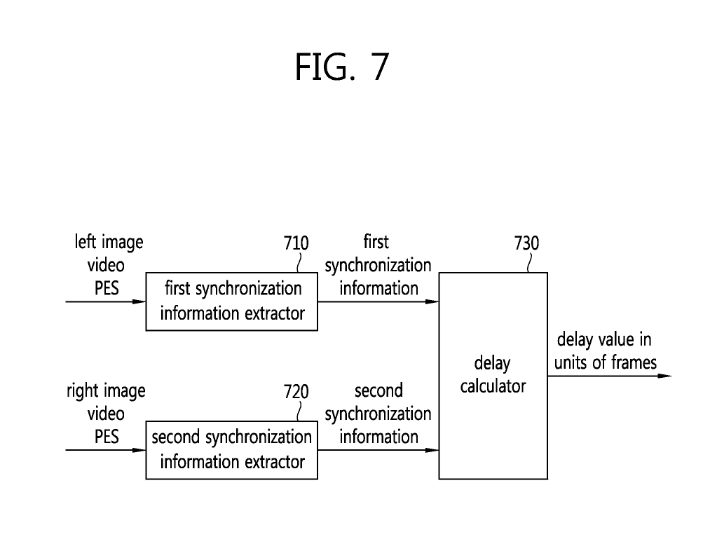

Operation of the delay calculation module 630 and synchronization information described above will be described in detail later with reference to FIG. 7.

Again, with reference to FIG. 6, the output control module 640 can generate and output synchronized PESs based on PESs input from the first PES storage buffer 610 and the second PES storage buffer 620; and a delay value in units of frames output from the delay calculation module 630. At this time, an example of PESs input from the first PES storage buffer 610 may be left image video and audio PES. Also, one example of PESs input from the second PES storage buffer 620 may be right image video and audio PES.

In what follows, left image video PES and left image audio PES are collectively called left image PES while right image video PES and right image audio PES, right image PES. In one embodiment, the output control module 640 the output control module 640, by outputting one PES signal of the left image PES signal and the right image PES signal with a delay in units of frames, can carry out synchronization between left and right images. In other words, in this case, the output control module 640 can output synchronized left image PES and synchronized right image PES.

At this time, the signal output being delayed from the output control module 640 may correspond to a signal proceeding in terms of time between the left image PES signal and the right image PES signal. As one embodiment, the output control module 640, based on the synchronization information included in ES within the left image PES and the synchronization information included in ES within the right image PES, can select a signal to be output being delayed from the left image PES signal and the right image PES signal. As one example, the output control module 640 can output a signal which has a larger synchronization value of the left image and the right image PES signal by delaying it in units of frames. Detailed description about synchronization information will be described with reference to FIG. 7.

FIG. 7 is a block diagram illustrating briefly one embodiment of a delay calculation module included in a synchronization module of FIG. 6. The delay calculation module according to an embodiment of FIG. 7 can comprise a first synchronization information extractor 710, a second synchronization information extractor 720, and a delay calculator 730.

With reference to FIG. 7, the first synchronization information extractor 710 can extract first synchronization information included in a video ES within a left image video PES (hereinafter, it is called ES1). Also, the second synchronization information extractor 720 can extract second synchronization information included in a video ES within a right image video PES (hereinafter, it is called ES2). In other words, the delay calculation module can extract synchronization information included in ES1 and ES2. The delay calculator 730, by calculating a frame difference between a left image PES and a right image PES based on first synchronization information and second synchronization information, can derive and output a delay value in units of frames. In other words, the delay calculator 730 can derive a time difference in units of frames between the left image PES and the right image PES.

In one embodiment, a synchronization information value included in a video ES may be the value which increments by one unit of frame. In other words, in the embodiment of FIG. 7, a difference between first synchronization information and second synchronization information may correspond to a delay value in units of frames. For example, if first synchronization information within ES1 is 5 and second synchronization information within ES2 is 2, the delay value in units of frames derived from the delay calculator corresponds to 3.

In another embodiment, synchronization information included in a video ES may correspond to information in the form of time code. In other words, the synchronization information may be the value included in a video ES in the form of time code consisting of hour, minute, second, and frame. In this case, the delay calculator 730 calculates a difference between first synchronization information and second synchronization information (e.g., a time difference in units of seconds between a left image PES and a right image PES) and multiply the time difference with the number of frames per second, thereby deriving a delay value in units of frames. For example, if the time difference is 0.5 second and the frames per second is 30, the delay value in units of frames is 15.

In case of using an MPEG-2 video encoder, the synchronization information described above may be included in a user data area of a video ES. Here, the user data may be represented by user_data, for example. At this time, the value of the synchronization information may correspond to the value which increments by one unit of frame and/or which is counted in units of frames, for example. As another example, the value of the synchronization information may correspond to the value included in the form of time code consisting of hour, minute, second, and frame. In case of using an AVC and/or HEVC (High Efficiency Video Coding) encoder, the synchronization information described above may be included in a video ES in the form of SEI (Supplemental Enhancement Information). The position at which synchronization information is inserted and/or type of synchronization information may be a predetermined position and/or a predetermined type. At this time, the delay calculation module can know the position at which synchronization information is inserted in a video ES and/or type of synchronization information without using separate information.

A delay calculation module (and/or delay calculator 730) may include a function such that the value of synchronization information used for calculating a delay in units of frames is substituted with a null value or changed after calculation of the delay in units of frames. Synchronization information for utilizing closed captions may be inserted in the user data area in a video ES. Here, closed caption may refer to character strings provided in synchronization with a voice of a broadcasting program, which is displayed on the screen only when the function of closed caption is activated. At this time, in case of providing actual subtitle information, confusion may arise between synchronization information for closed captions and synchronization information for synchronizing a plurality of image signals. Therefore, to reduce the confusion, the delay calculation module (and/or the delay calculator 730) can delete synchronization information used for calculating a delay in units of frames.

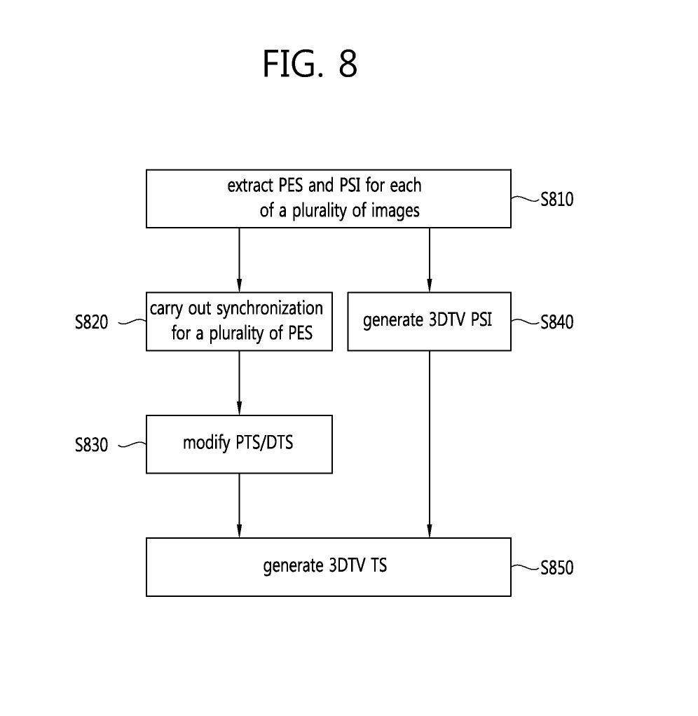

FIG. 8 is a flow diagram illustrating briefly one embodiment of a method for 3DTV multiplexing based on automatic synchronization according to the present invention.

With reference to FIG. 8, a 3DTV multiplexer according to an embodiment of the present invention can extract PES and PSI of each of a plurality of images S810.

For example, in case of stereoscopic 3DTV services, left image TS and right image TS may be input to a 3DTV multiplexer. At this time, the 3DTV multiplexer can extract or generate left image audio PES, left image video PES, and left image PSI based on left image TS. Also, the 3DTV multiplexer can extract or generate right image audio PES, right image video PES, and right image PSI based on right image TS.

Again, with reference to FIG. 8, the 3DTV multiplexer, by carrying out synchronization of a plurality of PES extracted or generated, can output a plurality of synchronized PES S820. As one example, the 3DTV multiplexer can extract synchronization information from ES included in each of a plurality of PES and based on the extracted synchronization information, can carry out synchronization of left image signal and right image signal in units of frames. Since detailed description about a method of carrying out synchronization and synchronization information have been provided earlier, further description thereof will not be provided.

Also, the 3DTV multiplexer, based on a new PTS value input from a clock, can modify PTS/DTS value for each of a plurality of synchronized PES into a new PTS/DTS value S830. Since an embodiment of a method for modifying a PTS/DTS value has been described in detail earlier, further description thereof will not be provided.

Again, with reference to FIG. 8, the 3DTV multiplexer, based on left image PSI and right image PSI, can generate 3DTV PSI corresponding to the program structure information S840. Here, the 3DTV PSI can comprise PAT information, PMT information, and so on.

Next, the 3DTV multiplexer can generate and output 3DTV TS by carrying out multiplexing based on a plurality of synchronized PES, PCR which is the time information generated by the clock, and 3DTV PSI S850.

According to the method for generating 3DTV TS described in detail above (and/or a method for 3DTV multiplexing based on automatic synchronization), a plurality of encoded streams may be automatically synchronized and multiplexed. The present invention can extract synchronization information included in each of encoded streams output from a plurality of encoders and based on the extracted synchronization information, synchronize multiplex a plurality of encoded streams in units of frames. As one example, in case of stereoscopic 3DTV services, an apparatus for 3DTV multiplexing based on automatic synchronization according to the present invention can receive left image MPEG-2 transport stream (TS) and right image MPEG-2 transport stream (TS). At this time, the apparatus can carry out synchronization in units of frames against left image transport stream and right image transport stream, based on the synchronization information included in ES within each of the transport streams. An apparatus for 3DTV multiplexing based on automatic synchronization can carries out multiplexing against a plurality of synchronized streams; and generate and output 3DTV transport streams.

Although the embodiments above have been described with respect to stereoscopic 3DTV services, the present invention is not limited thereto. The present invention can be applied in the same way as or similarly to the embodiments above not only for stereoscopic 3D images but also for the case where a plurality of images such as free-viewpoint images, multi-view images, and panoramic images are stored or processed together.

According to the present invention, a drawback of 3DTV multiplexer based on manual synchronization can be solved. The present invention can provide a 3DTV service by using a plurality of conventional DTV encoders without using a high-priced, dedicated 3DTV encoder, providing usefulness from the economic aspect. Also, the present invention is expected to contribute to the invigoration of 3DTV services by minimizing economic burden on 3DTV service providers. Meanwhile, as described above, a method for multiplexing based on automatic synchronization according to the present invention has an advantage that it can be extended to be applied to a video service comprising a plurality of images (and/or multi-images) in association with each other such as multi-view 3D images, free-viewpoint images, and UHDTV service systems carrying out parallel processing.

Although the embodiments above describe the methods of the present invention as a series of steps or blocks with reference to flow diagrams, the present invention is not limited by the order of the steps; some steps may be carried out in different steps from the steps described above in a different order or simultaneously. Also, it should be clearly understood by those skilled in the art that the steps introduced in the flow diagrams are not exclusive; other steps may be incorporated or one or more steps of the flow diagrams may be removed without affecting the technical scope of the present invention.

The embodiments above include various kinds of examples. Although it is not possible to describe all the possible combinations for illustrating various kinds of examples, it would be understood by those skilled in the art that other combinations are possible. Therefore, it might be said that the present invention accommodates all the other substitutions, modifications, and changes belonging to the technical scope defined by the appended claims.

According to a method for generating 3DTV TS of the present invention can improve efficiency of video services.

According to a method for 3DTV multiplexing of the present invention can improve efficiency of video services.

According to a method for synchronizing images of the present invention can improve efficiency of video services.

What is claimed is:

1. A method for 3DTV multiplexing, comprising:
deriving a delay value in units of frames for the left image and the right image, based on a left image PES (Packetized Elementary Stream) corresponding to a left image and a right image PES corresponding to a right image;
carrying out synchronization of the left image PES and the right image PES, based on the delay value in units of frames; and
generating 3DTV transport streams (TSs) by carrying out multiplexing of the synchronized left image PES and the synchronized right image PES,
wherein the delay value in units of frames corresponds to a time difference between the left image and the right image expressed in units of frames.

2. The method of claim 1, wherein the step of deriving a delay value in units of frames further comprises extracting a first synchronization information value from a first video ES (Elementary Stream) within the left image PES and extracting a second synchronization information value from a second video ES within the right image PES; and
deriving the delay value in units of frames based on the first synchronization information value and the second synchronization information value.

3. The method of claim 2, wherein the first synchronization information value is counted in units of frames and included in the first video ES, and the second synchronization information value is counted in units of frames and included in the second video ES; and
the step of deriving the delay value in units of frames comprises determining a time difference between the first synchronization information value and the second synchronization information value by the delay value in units of frames.

4. The method of claim 2, wherein the first synchronization information value is a value included in the first video ES in the form of a time code, and the second synchronization information value is a value included in the second video ES in the form of a time code and
the step of deriving the delay value in units of frames further comprises deriving a time difference in units of seconds between the first synchronization information value and the second synchronization information value; and
deriving the delay value in units of frames by multiplying the time difference in units of seconds with the number of frames per second.

5. The method of claim 1, wherein the synchronized left image PES further comprises a first PTS (Presentation Time Stamp) and a first DTS (Decoding Time Stamp), and the synchronized right image PES further comprises a second PTS and a second DTS; and
the step of carrying out synchronization further comprises modifying values of the first PTS, the first DTS, the second PTS, and the second DTS into new values, based on a third PTS fed from a clock.

6. The method of claim 5, wherein the modifying step further comprises:
modifying a value of the first PTS and a value of the second PTS into a value of the third PTS;
modifying a value of the first DTS into a value obtained by adding the value of the third PTS to a value obtained after subtracting the value of the first PTS from the value of the first DTS; and
modifying a value of the second DTS into a value obtained by adding the value of the third PTS to a value obtained after subtracting the value of the second PTS from the value of the second DTS.

7. The method of claim 1, further comprising generating 3DTV PSI, which is 3D program structure information, based on left image PSI (Program Specific Information) corresponding to the left image and right image PSI corresponding to the right image, wherein the step of generating 3DTV TS comprises carrying out multiplexing of the synchronized left image PES, the synchronized right image PES, and the 3DTV PSI.

8. The method of claim 7, wherein the left image PSI includes a first PAT (Program Association Table) and a first PMT (Program Map Table), and the right image PSI includes a second PAT and a second PMT,
and wherein the step of generating 3DTV PSI further comprises:
generating a third PAT having information corresponding to both of the first PMT and the second PMT by re-composing the first PAT and the second PAT;
changing a stream type value within one PMT corresponding to an additional stream from among the first PMT and the second PMT; and
inserting in one PMT corresponding to the additional stream, program information descriptor in which information specifying type of program provided by digital broadcasting is defined, and video information descriptor in which information specifying characteristics of ES constituting video data is defined.

9. The method of claim 1, further comprising extracting the left image PES from a left image TS (transport stream) corresponding to the left image and extracting the right image PES from a right image TS corresponding to the right image.

10. An apparatus for 3DTV multiplexing, comprising:
a delay calculation module for deriving a delay value in units of frames with respect to the left image and the right image, based on a left image PES (Packetized Elementary Stream) corresponding to a left image and a right image PES corresponding to a right image;
a synchronization module for carrying out synchronization between the left image PES and the right image PES, based on the delay value in units of frames; and
a 3DTV TS packetizer for generating 3DTV transport streams (TSs) by carrying out multiplexing of the synchronized left and right image PES,
wherein the delay value in units of frames corresponds to a time difference between the left image and the right image expressed in units of frames.

11. The apparatus of claim 10, wherein the delay calculation module further comprises:
a first synchronization information extractor extracting a first synchronization information value from a first video ES (Elementary Stream) within the left image PES;
a second synchronization information extractor extracting a second synchronization information value from a second video ES within the right image PES; and
a delay calculator deriving the delay value in units of frames based on the first synchronization information value and the second synchronization information value.

12. The apparatus of claim 10, wherein the synchronized left image PES further comprises a first PTS (Presentation Time Stamp) and a first DTS (Decoding Time Stamp); and the synchronized right image PES further comprises a second PTS and a second DTS; and
the synchronization module further comprises a PTS/DTS modifying module which modifies values of the first PTS, the first DTS, the second PTS, and the second DTS into new values, based on a third PTS fed from a clock.

13. The apparatus of claim 10, further comprising a 3DTV PSI generation module for generating 3DTV PSI, which is 3D program structure information, based on left image PSI (Program Specific Information) corresponding to the left image and right image PSI corresponding to the right image, wherein the 3DTV TS packetizer carries out multiplexing of the synchronized left image PES, the synchronized right image PES, and the 3DTV PSI.

14. The apparatus of claim 10, further comprising a first de-packetizer extracting the left image PES from a left image TS (transport stream) corresponding to the left image; and
a second de-packetizer extracting the right image PES from a right image TS corresponding to the right image.

15. A method for synchronizing images, comprising:
deriving a delay value in units of frames with respect to the left image and the right image, based on a left image PES (Packetized Elementary Stream) corresponding to a left image and a right image PES corresponding to a right image; and
carrying out synchronizing the left image and the right image PES with each other, based on the delay value in units of frames,
wherein the delay value in units of frames is a time difference between the left image and the right image expressed in units of frames.
